(19) United States
(12) Patent Application Publication
(10) Pub. No.: US 2011/0068890 A1
(43) Pub. Date: Mar. 24, 2011

(54) NTC THIN FILM THERMAL RESISTOR AND A METHOD OF PRODUCING IT

(75) Inventors: Chuanren Yang, Chengdu (CN); Hongwei Chen, Chengdu (CN); Jihua Zhang, Chengdu (CN); Lijun Yang, Chengdu (CN)

(73) Assignee: University of Electronic Science and Technology of China, Chengdu (CN)

(21) Appl. No.: 12/919,169

(22) PCT Filed: Dec. 5, 2008
(86) PCT No.: PCT/CN2008/073343

§ 371 Date: Nov. 30, 2010

(30) Foreign Application Priority Data
Mar. 12, 2008 (CN) 200810044961.7
Aug. 28, 2008 (CN) 200810304256.6

(51) Int. Cl. H01C 7/04; H01C 7/02

(52) U.S. Cl. 338/22 R; 29/612

(57) ABSTRACT

This invention relates to a method for thin film device. The method for manufacturing a thin film negative temperature coefficient thermistor is disclosed. It includes selecting a substrate, a temperature-sensitive layer, inner electrodes, a protective layer and end electrodes. The temperature-sensitive layer is an NTC thin film, the inner electrodes have a comb-shaped structure. The resistance value of the present invention can be regulated by changing material composition and the width, gap, length of comb-shaped electrodes, which are not influenced by the error of the thermistor physical size. In present invention, a high temperature glaze is engaged to smooth the surface of cheaper ceramic substrates. This process reduces the manufacturing cost, improves the structure, enhances the reliability and the yield and thus expands the application scope of the NTC thin film thermistor chips. The invention has an industrial practicability.

### TECHNICAL AREA

This invention discloses a thin film NTC thermistor chip and its manufacturing method.

### BACKGROUND OF THE INVENTION

Negative Temperature Coefficient (NTC) thermistors are usually made of NTC thermal materials, such as transition metal oxides with resistivity decreasing exponentially with increasing temperature. The special property makes these transition metal oxides ideal as temperature sensing materials. Conventional NTC thermistor is manufactured from bulk NTC materials, the huge volume and thermal capacity greatly reduces the response time of the device. Meanwhile, the mechanical process, such as cutting, grinding and polishing, is utilized to ensure the consistency of the physical size of high precision bulk NTC thermistors, so that the required accuracy of these thermistor chips are difficult to achieve. Moreover, automated mass production can hardly be applied to in manufacturing of existing NTC thermistors. So the consistency and the reliability of the products is poor, and manufacture cost is high.

The current process of making NTC thermistors has a number of deficiencies. Japanese Patent Publication Tokkai 01-50501, for example, disclosed an NTC thermistor that makes use of temperature-sensitive transition metal (such as Mn, Ni, Co, Fe and Cu) oxide. Those materials are widely used in production of bulk NTC thermistors. Such thin films materials usually have high resistivity and the structure of the thin film thermistor is unsuitable, thus the resistance of the thermistor is too high to be widely applied. In addition, during manufacture, plasma treatment is required after the film was prepared by high-frequency sputtering, resulting in a prolonged manufacturing time.

Japanese Patent Publication 63-266801 disclosed a thin film thermistor in which the electrodes were printed on both sides of a temperature sensitive thin film layer. However, the resistance of the temperature sensitive thin film in this type of NTC thermistor is extremely small. Meanwhile, short circuits occur frequently because of the electrodes are separated by the extremely thin sensitive layer.

U.S. Pat. No. 6,368,734 B1, for example, disclosed a thin film NTC thermistor formed by LaCoO₃ thin films. The resistance of this type of NTC thermistor is much lower than that of transition metal (such as Mn, Ni, Co, Fe and Cu) oxides. However, the negative temperature coefficient of LaCoO₃ is very small which reduces the sensitivity of thermistors and shorten the range of negative temperature coefficient. Meanwhile, because there is only one material available, a series of resistivity and temperature coefficients can not be achieved.

U.S. Pat. No. 6,880,234 B2, for example, reported a method to flatten the surface of the substrate by silicon nitride. Whereas, microscopic holes can't be completely padded in ceramic substrates, so that nanoscale smoothness of the surface can't be achieved.

The single-crystal substrates (such as sapphire, Si, MgO, LaAlO₃ or GaN, etc.) or mechanically polished ceramic substrates are commonly used in currently thin film technologies. The expensive substrates greatly increase the costs of thin film NTC thermistors. In addition, there are microscopic defects on the surface of polished ceramic substrates. These defects result in discontinuities in NTC thin films and inner electrodes, and hence, loss, disconnection and short circuits might appear.

### DETAILED DESCRIPTION OF THE INVENTION

A technical problem for manufacturing a thin film negative temperature coefficient thermistor is disclosed. The present invention provides a method engaged glaze to smooth the surface of ceramic substrates. The glaze can reduce the surface roughness of the substrate from micro-scale to nano-scale, thereby fulfilling the manufacturing standards that are required for thin film devices. The method also includes selecting a pair of comb-shaped electrodes structure and selecting transition metal oxides as the temperature-sensitive materials to overcome the problem of over high resistance in thin film NTC thermistors.

The techniques in present invention to overcome the technical issues mentioned above are described as follows:

NTC thin film thermistor chips comprise a substrate, a temperature-sensitive layer, a pair of inner electrodes and a pair of terminal electrodes. It has the following features: there is a high temperature glaze layer between the substrate and the temperature-sensitive layer. The high temperature glaze layer is used for planarization the surface of substrate.

Firstly, the NTC thin film is made of transition metal oxide materials.

The manufacturing process of such an NTC thin film thermistor may be formed as follows.
A. Prepare a high temperature glaze on the surface of the ceramic substrate.
B. Prepare the temperature-sensitive layer on the surface of aforesaid high temperature glaze.
C. Prepare the inner electrodes on the surface of aforesaid temperature-sensitive layer.
D. Prepare the protection layer.
E. Prepare the terminal electrodes.
F. Cut into slices to obtain thin film thermistors.

Next, the high temperature glaze is formed by the Sol-Gel method. The detailed process is as follows:
A1). The sol that contains a high temperature glaze component is prepared.
A2). The ceramic substrate undergoes a conventional cleaning treatment.
A3). The high temperature glaze sol is coated on the aforesaid substrate.
A4). The sol undergoes a gelation and a drying process.
A5). Sinter the high temperature glaze layer.

The NTC thin film thermistor chips also include a temperature-sensitive layer that is deposited by reactive sputtering method. The temperature-sensitive layer is made of a transition metal oxid. The detailed process is as follows:
B1). Prepare the transition metal alloy target.
B2). The transition metal oxide is deposited on the substrate to form a thin film by the sputtering method.
B3). The sensitive layer undergoes an annealing treatment.

The inner electrodes are deposited on the metal oxide solid solution film by evaporation or sputtering method. The inner electrodes materials may consist of gold, copper, aluminium or other conductive materials. The processing steps are as follows:
C1). The inner electrode material is deposited on the surface of the temperature-sensitive layer to form a conductive thin film by evaporation or sputtering method.
C2). The conductor layer is then etched to be comb-shaped inner electrodes by photolithography and etching method.

The Ag/Ni/Sn three-layer-electrodes are prepared by electroplating technique.

The benefit of the present invention is that a high temperature glaze is engaged to smooth the surface of cheaper ceramic substrates. This process reduces the manufacturing costs of the NTC thin film thermistor and improves the structure of the NTC thin film thermistor, thus enhance the reliability and the yield. In present invention, the performance of the NTC thin film thermistor is improved and the applicability is expanded by transition metal oxides as the temperature-sensitive material. The resistance value of the present invention can be regulated by changing material composition and the width, gap, length of comb-shaped electrodes, which do not be influenced by the error of the thermistor physical size. So, the present invention provides a manufacturing method of NTC thin film thermistors for reduced costs, improved reliability and yield.

### BRIEF DESCRIPTION OF THE DRAWING

FIG. 1 is a structure of the NTC thin film thermistor.

Of which, 1. ceramic substrate, 2. high temperature glaze layer, 3. temperature-sensitive layer, 4. inner electrodes, 5. protective layer, 6. terminal electrodes.

FIG. 2 is a flow chart showing the manufacturing process for the NTC thin film thermistor of present invention.

FIG. 3 is a scanning electron microscopy (SEM) surface image of the ceramic substrate.

FIG. 4 is a SEM surface image of the high temperature glaze on the ceramic substrate.

FIG. 5 is a 3D atomic force microscopy (AFM) surface image of the high temperature glaze on the ceramic substrate.

FIG. 6 is a resistance-temperature characteristic curve of a typical NTC thin film thermistor.

### DESCRIPTION OF THE PREFERRED EMBODIMENT

This invention relates to NTC thermistor chips, and more particularly to a planarization process of preparing an improved surface via coating a high temperature glaze layer on the surface of the substrate. It also combines advanced reactive sputtering technology to prepare a transition metal oxide thin film as the temperature-sensitive layer and use etched comb-shaped electrodes as the inner electrodes. These processes increase the accuracy of the NTC thermistors, reduce its resistance and expand the applicability of the products.

### Implementation Example

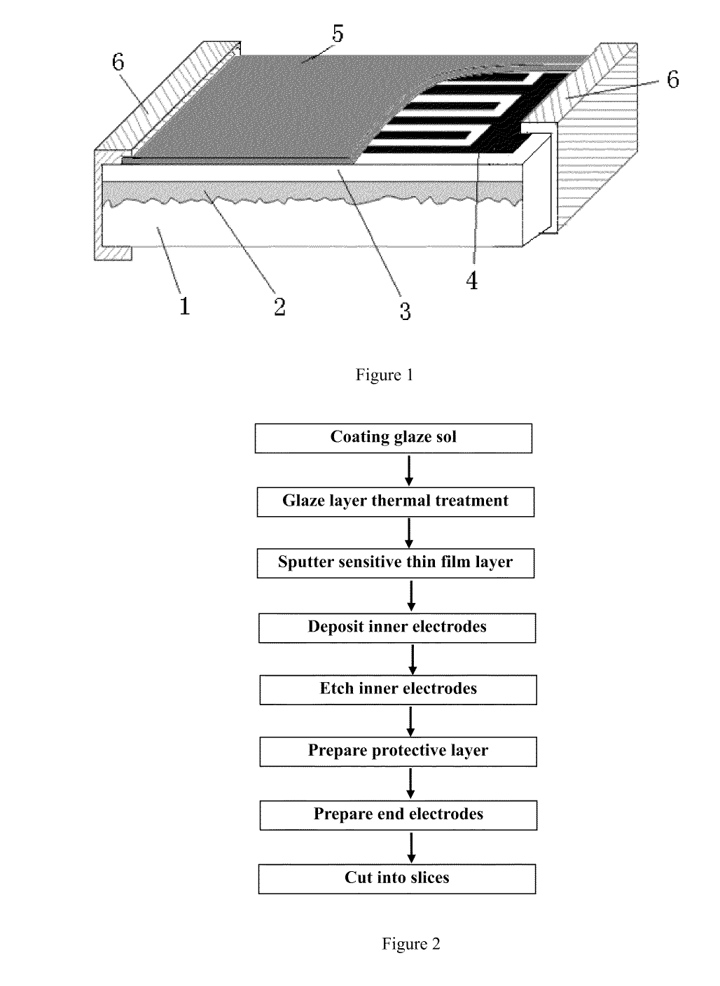

As shown in FIG. 1, the disclosed NTC thin film thermistor comprises an electrical insulating ceramic substrate 1, a high temperature glaze 2, a temperature-sensitive layer 3, a pair of comb-shaped inner electrodes 4, a protection layer 5 and a pair of terminal electrodes 6. The substrate has a high temperature glaze layer used for planarization. The dents on the surface of the substrate 1 are filled up by the high temperature glaze 2 between the substrate 1 and the sensitive layer 3. So, the surface of the substrate 1 is ensured smooth. The NTC thermistor chip also includes a temperature-sensitive thin film layer which is a transition metal (such as Mn, Ni, Co, Fe or Cu, etc.) oxide solid solution thin film. In FIG. 1, the inner electrodes 4 are made of conductive metal thin film. The conductor layer is then etched to be comb-shaped inner electrodes by photolithography and etching method (also referred to as an interdigitated electrode structure). This type of electrodes can increase the current carrying area and greatly reduce the resistance value, and the resistance value can be precisely regulated by changing the width, gap and length of the interdigitating fingers. In this example, the substrate 1 is an Al₂O₃ ceramic substrate. The dents on the Al₂O₃ ceramic substrate can be filled by a high temperature glaze layer 2 between the sensitive layer 3 and the substrate 1, thereby mechanical polishing of the substrate 1 is not required in this case.

The processing flow for the NTC thin film manufacturing example of the present invention is shown in FIG. 2. The processing steps are as follows:

A. The high temperature glaze layer is formed on the surface of the unpolished Al₂O₃ ceramic substrate using the Sol-Gel method, the detailed steps are listed below:
A1. Ca—Al—Si series or Mg—Al—Si series high temperature glaze sol is prepared using tetraethoxyorthosilicate as the complexant.
A2. The ceramic substrate undergoes a conventional cleaning treatment.
A3. The high temperature glaze sol is coated on the surface of aforesaid substrate. The applying method can be spin-coating, dipping, spraying or impregnating.
A4. The high temperature glaze sol on the surface of substrate is gelated and dried.
A5. A high temperature sintering treatment is performed.

In the aforesaid glaze preparing processes, the softening temperature of the glaze may be obtained at 1100-1500° C. by selecting an appropriate composition. This relatively high softening temperature for the glaze can ensure to withstand the high temperature in the later thermal treatment processing of temperature-sensitive layer. Additionally, the high temperature glaze does not contain any alkali metal ion. This helps to improve the electrical performance of the high temperature glaze.

B. The temperature-sensitive layer is deposited on the surface of the aforesaid glaze by the reactive sputtering method. The temperature-sensitive material is a transition metal oxide. The detailed processing steps are as follows:
B1. The transition metal alloy target is prepared.
B2. The transition metal oxide is deposited on the glaze surface to form a thin film by the reactive sputtering method.
B3. The sensitive layer is heated treatment.
   C. The inner electrodes are prepared on the surface of the aforesaid sensitive layer by evaporation or sputtering techniques. Au, Al, Pd, Cu, or other conductive materials can be used as inner electrodes material. The detailed processing steps are as follows:
C1. The inner electrode material is deposited on the surface of the temperature-sensitive layer to form a conductive thin film by evaporation or sputtering method.
C2. The conductive thin film layer is then etched into comb-shaped inner electrodes (interdigitated electrodes) by photolithography and etching.
   D. Prepare the protective layer. A SiO₂ or Si₃N₄ layer is deposited on the surface of the inner electrodes by the plasma enhanced chemical vapor deposition (PECVD) or sputtering. And then, the protective layers on each end are etched to expose the conductive layer so that the terminal electrodes can be made.
   E. Prepare the terminal electrodes. The terminal electrodes are prepared by the sintering silver or electroplating method. The terminal electrodes material can be Ag, Ni, Sn or other conductive metal. A three-layer end electrode of Ag/Ni/Sn is used in this example.
   F. Cut into slices to obtain thin film thermistors.

The advantages of the present invention are as follows: A high temperature glaze is coated on the cheaper unpolished ceramic substrate to obtain the substrate with improved planar surface for the requirement of thin film circuits. The planarized substrate can replace the single crystal substrate (for example single crystal Si, LaAlO₃, MgO, sapphire and GaN, etc.), or the mechanically polished substrates. Thus, the present invention has a great significance to reduce the manufacturing cost of NTC thin film thermistor chips. Meanwhile, the NTC thin film thermistor chip made by the method mentioned in this invention possesses a special device structure that comprises a high temperature glaze layer, a temperature-sensitive layer, inner electrodes, a protective layer and terminal electrodes. The resistance value and the temperature sensitivity coefficient of the NTC thin film thermistor can be regulated by changing material composition of temperature-sensitivity layer and the width, gap, length of the interdigitating fingers in the inner electrodes.

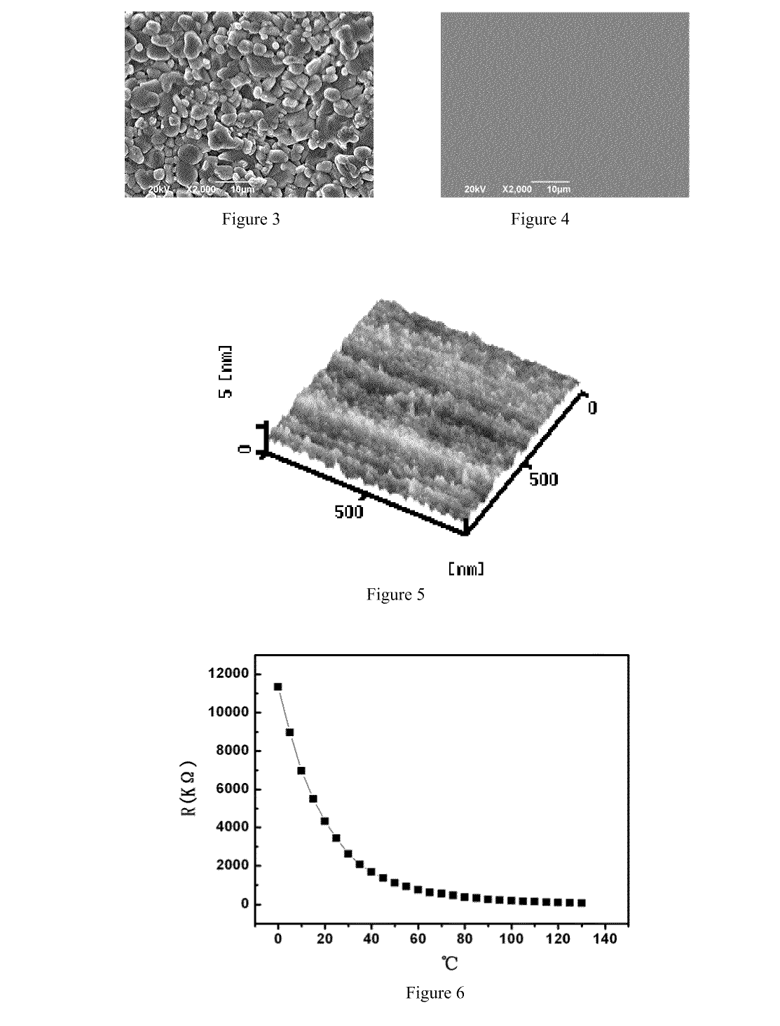

FIGS. 3 and 4 show the SEM surface images of unpolished Al₂O₃ ceramic substrate and treated Al₂O₃ ceramic substrate with the methods described in this invention. It can be seen that the surface roughness of the substrate treated with the methods described in this invention (FIG. 4) has been significantly improved. The index of the treated substrate is more superior than that of mechanically polished substrate.

FIG. 5 shows a 3D AFM surface image of the Al₂O₃ substrate treated with the methods described in this invention. It can be seen that the surface of the substrate covered with high temperature glaze is smooth, the root-mean-square (RMS) value is calculated to 0.55 nm and the difference of peak and valley is less than 5 nm.

FIG. 6 shows the DSC and TG curves of a high temperature glaze materials of the CaAlSi series from room temperature to 1400° C. From this chart, it can be concluded that the high temperature glaze softening temperature is about 1340° C., the substrate is capable of withstanding above 1000° C. thermal treatment temperature without reacting with the thin film material.

What is claimed is:

1. An NTC thin film thermistor which comprising:
a substrate, a temperature-sensitive layer, inner electrodes, and end electrodes. It has the following features: the said thermistor has a glaze layer between the substrate and the temperature-sensitive layer. The glaze layer is used for planarization the surface of said substrate.

2. The NTC thin film thermistor of claim 1 wherein said NTC thin film is constructed from transition metal oxides.

3. The NTC thin film thermistor of claims 1 and 2 wherein said inner electrodes have a comb-shaped structure.

4. The NTC thin film thermistor of claim 1, 2 or 3 wherein the aforesaid substrate is an unpolished ceramic substrate.

5. The NTC thin film thermistor chip of claim 4 wherein the softening temperature of said high temperature glaze is 1100-1500° C.

6. The manufacturing process of such an NTC thin film thermistor may be formed as follows.
A. Prepare a glaze layer on the surface of the ceramic substrate.
B. Prepare the temperature-sensitive layer on the surface of the aforesaid glaze.
C. Prepare the inner electrodes on the surface of the aforesaid temperature-sensitive layer.
D. Prepare the protection layer.
E. Prepare the terminal electrodes.
F. Cut into slices to obtain thin film thermistors.

7. The method of manufacturing a NTC thin film thermistor of claim 6 has this feature: in step A, the high temperature glaze may be formed by the Sol-Gel method. The detailed processes are as follows.
A1). The solution that contains a glaze component is prepared.
A2). The ceramic substrate undergoes a conventional cleaning treatment.
A3). The glaze solution was coated on the aforesaid substrate.
A4). The solution undergoes gelation and a drying process.
A5). Sinter the high temperature glaze layer.

8. The NTC thin film thermistor of claims 7 wherein said glaze is a CaAlSi series or a MgAlSi series glaze that does not contain alkali metal ions.

9. The method of manufacturing a NTC thin film thermistor of claim 7 has this feature: in step A1, tetraethoxyorthosilicate is used as the complexant.

10. The method of manufacturing a NTC thin film thermistor of claim 10 has this feature: in step A3, the method of coating the high temperature glaze solution can be spin-coating, dipping, spraying or impregnating.

11. The NTC thin film thermistor of claim 6-10 wherein the softening temperature of said glaze is 1100-1500° C.

12. The method of manufacturing a NTC thin film thermistor of claim 6 has this feature: in step B, a temperature-sensitive layer is deposited by a reactive sputtering method. The temperature-sensitive layer is made of transition metal oxide. The detailed processes are as follows.
B1). Prepare the transition metal oxide target.
B2). The transition metal oxide is deposited on the glaze surface to form a thin film by the sputtering method.
B3). The sensitive layer undergoes annealing treatment.

13. The method of manufacturing a NTC thin film thermistor of claim 6 has this feature: in step C, the inner electrodes are deposited on the metal oxide mixture film by evaporation or sputtering methods. The inner electrodes materials may consist of gold, copper, aluminium or other conductive materials. The processing steps are as follows.
C1). The inner electrode material is deposited on the surface of the temperature-sensitive layer to form a conductive thin film by evaporate or sputter method.
C2). The conductor layer is then etched to be comb-shaped inner electrodes by photolithography and etching method.

14. The NTC thin film thermistor of claim 6 wherein the aforesaid end electrodes are Ag electrodes or Ag/Ni/Sn three-layer electrodes.
